(19) United States
(12) Patent Application Publication
(10) Pub. No.: US 2004/0124909 A1
(43) Pub. Date: Jul. 1, 2004

(54) Arrangements providing safe component biasing

(76) Inventors: Nazar Syed Haider, Fremont, CA (US); Ahmad Siddiqui, Sunnyvale, CA (US); Sooseok Oh, San Jose, CA (US)

Correspondence Address: Edwin H Taylor, Blakely Sokoloff Taylor & Zafman LLP, 12400 Wilshire Blvd, Seventh Floor, Los Angeles, CA, 90025, US

(21) Appl. No.: 10/334,069

(22) Filed: Dec. 31, 2002

(51) Int. Cl. G05F 1/10

(52) U.S. Cl. 327/540

(57) ABSTRACT

Arrangements (methods, apparatus, etc.) providing safe component biasing.

### FIELD

Embodiments of the present invention relate to arrangements (methods, apparatus, etc.) providing safe component biasing.

### BACKGROUND

As semiconductor integrated circuit (IC) technology advances, more and more support circuitry that had previously been provided off-die is being moved on-die. Such is advantageous to original equipment manufacturers (OEMs) in that all of costs, space requirements and design/build work associated with equipment manufacture is further minimized. A resultant popularity of use of the IC, in turn, is advantageous to the IC's manufacturer in that greater sales and profit are achieved.

Attempting to move a previously off-die circuit on-die is no simple task in that circuit operation within the semiconductor IC world has substantial differences/rules from that of off-die operation. One such difference/rule is that, as IC components become smaller-and-smaller, the components (e.g., transistors) may have voltage-sensitive structures that become more-and-more susceptible to damage caused by excessive voltages and/or currents. That is, as newer (i.e., more miniaturized) process generations continue to evolve, the ability of a transistor to withstand higher voltages and/or currents diminishes significantly. What are needed are continued improvements (arrangements) providing protection against excessive voltages and/or currents.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims.

The following represents brief descriptions of the drawings, wherein:

FIG. 1 is an example circuit arrangement useful in gaining a more thorough understanding/appreciation of the present invention;

FIGS. 2-4 are first through third example disadvantageous circuit arrangements useful in gaining a more thorough understanding/appreciation of the present invention;

FIG. 5 is an example advantageous circuit arrangement including an example embodiment of the present invention, such FIG. being useful in gaining a more thorough understanding/appreciation of the present invention;

FIG. 6 is an example cross-sectional view of an example transistor from the FIG. 4 disadvantageous circuit arrangement, such FIG. being useful in gaining a more thorough understanding/appreciation of the present invention;

FIG. 7 is an example cross-sectional view of an example transistor from the FIG. 5 advantageous circuit arrangement, such FIG. being useful in gaining a more thorough understanding/appreciation of the present invention;

FIG. 8 is an example flow 800 embodiment of the present invention; and

FIG. 9 illustrates example electronic system arrangements incorporating implementations of the present invention.

### DETAILED DESCRIPTION

Before beginning a detailed description of the subject invention, mention of the following is in order. When appropriate, like reference numerals and characters may be used to designate identical, corresponding or similar components in differing figure drawings. Further, in the detailed description to follow, example sizes/models/values/ranges may be given, although the present invention is not limited to the same. As manufacturing techniques (e.g., photolithography) mature over time, it is expected that devices, apparatus, etc., of smaller size could be manufactured. Well known power/ground connections to ICs and other components may not be shown within the FIGS. for simplicity of illustration and discussion, and so as not to obscure the invention. Further, arrangements may be shown in block diagram form and/or simplistic form in order to avoid obscuring the invention, and also in view of the fact that specifics with respect to implementation of such are highly dependent upon the platform within which the present invention is to be implemented, i.e., such specifics should be well within purview of one skilled in the art. Where specific details (e.g., circuits, flowcharts) are set forth in order to describe example embodiments of the invention, it should be apparent to one skilled in the art that the invention can be practiced without, or with variation of, these specific details.

An increasingly versatile circuit used within varying applications within the semiconductor industry is an operational transconductance amplifier (OTA). Although example embodiments of the present invention will be described using on-die examples with OTA arrangements, practice of the invention is not limited thereto. That is, the invention may be able to be practiced with other types of circuit arrangements (e.g., non-OTA circuits such as: other types of operational amplifiers (op-amp); non-operational-amplifier circuit arrangements), and in other types of environments (e.g., off-die).

Turning now to detailed discussions, voltage/current sensitive components may have predetermined voltage ratings. For example, Vmax is the voltage that a particular transistor of a given process can withstand without adversely degrading its performance or causing a failure within a prescribed window of time. Exceeding the Vmax voltage ratings may result in a failure that is sometimes referred to as oxide degradation of the transistor.

As mentioned previously, as newer (further miniaturized) process generations continue to evolve, the ability for a transistor to withstand higher voltages diminishes considerably. Using one illustrative example, the Vmax of an example 0.13 um process was found to be around 1.6V, while the Vmax for a smaller 0.10 um process is predicted to be 1.2V. For any given process generation, this calls for design techniques and checks to guarantee that no transistor in that circuit is exposed to a higher voltage than the process Vmax. Specifically, designers need to guarantee that no transistor is exposed to a high Vgs (gate-to-source), Vgd (gate-to-drain) or Vgb (gate-to-bulk) voltage that is greater than Vmax of the process.

Almost contradictory to the above, in certain circuit applications it is of paramount importance that the circuits handle voltages that are higher than the Vmax voltage. In the microprocessor IC design world, analog circuits and I/O buffers fall into this category. One specific example analog circuit is a voltage regulator module (VRM) circuit. As FIGS. 1-4 may contribute to improved understanding of the present invention, such FIGS. will be first used as examples to discuss example (disadvantageous) VRM/OTA arrangements which may be susceptible to Vmax degradation problems.

More particularly, FIG. 1 is an example circuit arrangement 100 useful in gaining a more thorough understanding/appreciation of the present invention. The arrangement 100 is directed to a block/simplistic diagram of an example voltage regulator arrangement, and includes a voltage reference circuit 110, a noise filter 120, OTA 130, load pass transistor 140, decoupling capacitor 150, a current source 160 (possibly representative of a load), and a feedback network 170. Such components have example circuit interconnections as shown, with Vccp representing, for example, a high voltage supply (e.g., 1.5-1.6 volts) having a voltage level that is greater than Vmax, Vi− representing a negative (reference) input to the OTA 130, Vi+ representing a positive input to the OTA, Vo representing an output of the OTA, and Vout representing an output voltage of the voltage regulator circuit 100.

The main function of this circuit is to take in a high voltage supply (Vccp) and produce a regulated low voltage DC level for a prescribed load current. The high voltage input portions of this circuit may require careful design because voltages within the high voltage input portions may be higher than the allowable Vmax process voltage of ones of the components.

It is noted that OTAs may be most suitable for use in the design of this type of VRM circuit due to the fact that the load may be capacitive. Further, use of a p-channel transistor for the output pass transistor may result in better LDO (low drop-out voltage VRMS). Dropout voltage refers to the lowest voltage the output can drop to before the VRM loses control. During a normal mode of operation, the OTA transistors as well as the pass gate transistor are required to take as input a high voltage, but at the same time these components should be designed such that the Vgs, Vgb or Vgd are kept well below the process Vmax.

As the circuit 100 operates within its load limits, the output voltage Vout may drop or rise depending on the load current. This change in the output voltage Vout is fed back by the feedback network 170 to the Vi+ input and compared to the reference voltage applied to the Vi− input of the OTA 130. The OTA 130 amplifies any voltage difference between the voltages at its two inputs, and changes the output voltage Vo at its output to counter the voltage change at the main output of the voltage regulator. If the output voltage Vout drops, the OTA will force the output pass transistor 140 to turn on more strongly and vice versa. This enables the VRM module 100 to maintain a fairly constant voltage at its output.

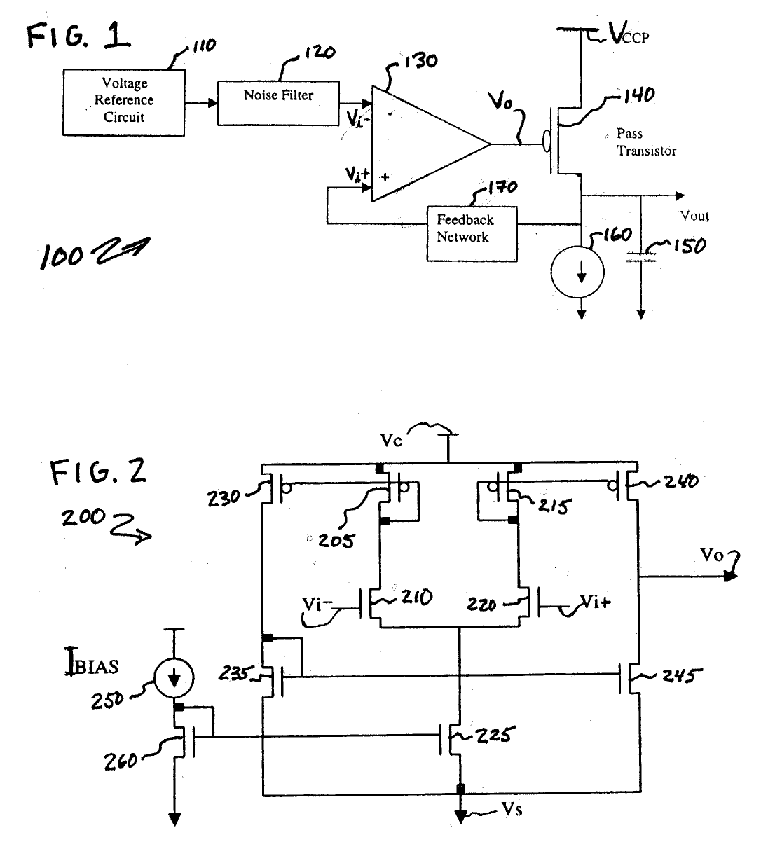

The design of an example basic configuration OTA (e.g., suitable for implementation within a semiconductor IC) is shown in FIG. 2. More particularly, FIG. 2 is a first example (disadvantageous) OTA circuit arrangement 200 useful in gaining a more thorough understanding/appreciation of the present invention. Included within the circuit are transistors 205, 210, 215, 220, 225, 230, 235, 240, 245 and 260, as well as an Ibias current source 250. Such components have example circuit interconnections as shown, with Vc representing, for example, a high voltage supply (e.g., 1.5-1.6 volts) interconnection (e.g., having a voltage level that is greater than Vmax), Vs representing, for example, a low voltage supply (e.g., ground) interconnection, Vi+ and Vi− representing ones of the reference and feedback voltages, and Vo representing an output voltage of the OTA circuit. FIG. 2 is limited in that it may have a limited allowable input swing.

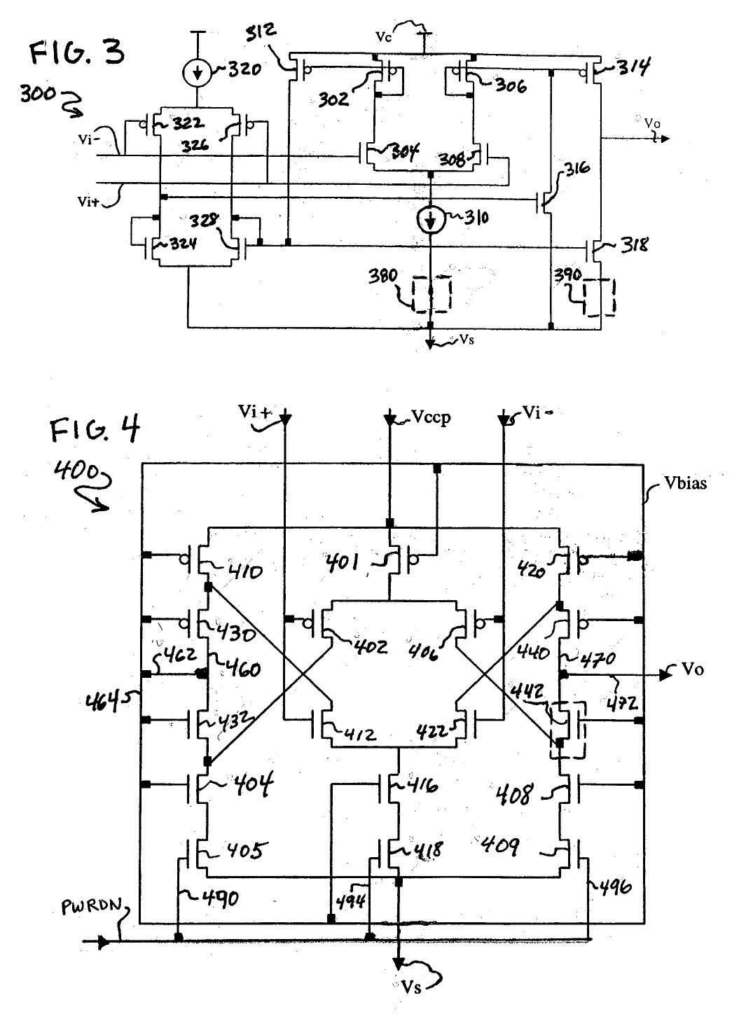

One technique that may be used to extend the allowable input swing (range) of the FIG. 2 basic OTA is to use two (e.g., parallel) complementary stages as shown in FIG. 3. Wide range refers to an improved common-mode range (CMR).

More particularly, FIG. 3 is a second example (disadvantageous) OTA circuit arrangement 300 useful in gaining a more thorough understanding/appreciation of the present invention. Included within the circuit are transistors 302, 304, 306, 308, 312, 314, 316, 318, 322, 324, 326, 328, as well as an current sources 310, 320. Such components have example circuit interconnections as shown to form two parallel complementary stages, with Vc representing, for example, a high voltage supply (e.g., 1.5-1.6 volts) interconnection (e.g., having a voltage level that is greater than Vmax), Vs representing, for example, a low voltage supply (e.g., ground) interconnection, Vi+ and Vi− representing ones of the reference and feedback voltages, and Vo representing an output voltage of the OTA circuit. Dash enclosed areas 380 and 390 are important for discussions provided further ahead.

In addition to improved CMR, a regulator may also be constructed to support non-normal circuit operations such as a disable feature whereby the output pass transistor needs to be turned off. Non-normal circuit operations may be any of power off, power down, power savings, testing, etc. modes. Practice of embodiments of the present invention are by no means limited to the listed non-normal operations.

Turn off of the FIGS. 2-3 example OTAs may require that the OTA raise its output voltage Vo such that the gate of the pass transistor is at a voltage level equal to its source. Such requirement results in design challenges that are not trivial.

One example OTA circuit design 400 that provides improved CMR (wide input range), while at the same time including an example non-normal circuit feature capable of disabling the output pass transistor of the FIG. 1 voltage regulator is shown in FIG. 4. Included within the circuit are transistors 401, 402, 404, 405, 406, 408, 409, 410, 412, 416, 418, 420, 422, 430, 432, 440, 442, as well as interconnects (of particular interest) 460, 462, 464 (aka, Vbias), 470, 472. Such components and interconnects (and other unnumbered interconnects) arranged as shown to form two parallel complementary stages, with Vccp representing, for example, a high voltage supply (e.g., 1.5-1.6 volts) interconnection (e.g., having a voltage level that is greater than Vmax), Vs representing, for example, a low voltage supply (e.g., ground) interconnection, Vi+ and Vi− representing ones of the reference and feedback voltages, and Vo representing an output voltage of the OTA circuit.

Although illustrated in a differing layout, at least a major portion of the FIG. 4 OTA design is very similar to the FIG. 3 OTA design. Of particular interest in later discussions, is the Vbias voltage provided via the interconnect 464. More particularly, a bias voltage formed at a node 460 (between transistors 430, 432) is fed via interconnect 462 to the distributing interconnect 464 (a distributing ring in FIG. 4), and Vbias is used to bias a majority of the transistors in the FIG. 4 OTA. An intermediate voltage formed at a node 470 (between transistors 440, 442) is fed via interconnect 472 as the output voltage Vo of the OTA 400.

One significant difference within the FIG. 4 circuit (over that of FIG. 3) is the inclusion of three pull-down n-channel transistors 405, 418, 409 that can be turned off by signal called, for example, PWRDN. The PWRDN signal is fed to the gates of the three pull-down transistors 405, 418, 409 via three interconnects 490, 494, 496, respectively. Note that there are basically three main electrical branches in FIG. 4, and that ones of the three pull-down transistors 405, 418, 409 each serve to control current paths of its respective branch.

Turn off of the three branches serves at least three purposes. First, turn-off raises the output voltage Vo to be equal to Vccp. Second, by cutting all current paths to ground, the FIG. 4 circuit can both save power as well as support testing such as static current testing of the IC. Third, the VRM output can be disabled.

The FIGS. 2-4 circuit designs may be inherently safe during normal (non-disabled) operation. However, when in non-normal circuit operations (e.g., disabled), these circuits may result in unsafe operation due to Vmax high voltage violations. Further discussion of FIG. 4 will be used to describe one example of unsafe operation.

More particularly, a disabled FIG. 4 circuit may result in internal node voltages rising above the process Vmax. More specifically, at least ones of the n-channel transistors may disadvantageously experience a gate voltage that rises to 1.5V resulting in an opposing Vgb (1.5V) voltage differential that is greater than the allowable process Vmax (1.2V).

As explanation, FIG. 6 is an example cross-sectional view 600 of an example transistor 442 from the FIG. 4 (see dash enclosed area) disadvantageous circuit arrangement, FIG. 6 being useful in gaining a more thorough understanding and appreciation of the present invention. More particularly, FIG. 6 illustrates a p-type substrate having a theoretical bulk B connection, a first n+ diffusion having a theoretical source S connection, a second n+ diffusion having a theoretical drain D connection, and an insulated gate provided on the substrate and having a theoretical gate G connection.

During turn-off of all three of the FIG. 4 pull-down transistors 405, 418, 409 (to controllably disrupt the current paths of the respective branches), the bulk B may eventually experience a voltage of substantially 0V (B=0V), while all of the source S, drain D and gate G may eventually experience substantially 1.5V (S=1.5V; D=1.5V; G=1.5V). Such would result in voltage differentials across the gate-source and gate-drain pairs that were substantially 0V (Vgs=0V; Vgd=0V), and thus safely below the present example Vmax of 1.2V.

However, the resultant gate G and bulk B voltages would result in a voltage differential across the gate-bulk pair that was substantially 1.5V (Vgb=1.5V). This 1.5V voltage differential disadvantageously and dangerously exceeds the present example Vmax of 1.2V. Accordingly, the likelihood is high that a catastrophic discharge (shown representatively within FIG. 6 by discharge-bolt 610) would occur through the gate oxide layer and result in oxide degradation. Oxide degradation may occur little by little over time (e.g., via multiple discharges), or may occur instantaneously (e.g., via a large catastrophic discharge). Any oxide degradation will damage a transistor permanently and irreversibly. Such catastrophic discharge may occur within the example transistor 442, and may also occur within any other ones of FIG. 4 OTA circuit's n-channel transistors.

Catastrophic discharge within any of the n-channel transistors may render the transistor inoperable (partially or totally), and any transistor inoperability may in turn render the FIG. 4 OTA partially or totally inoperable. If a voltage regulator including the OTA is implemented as a portion of an IC chip (such as a processor chip), then the malfunctioning circuit may render the entire IC chip inoperable. Such may disadvantageously result in IC discard during manufacturing, or IC failure during implementation in the field.

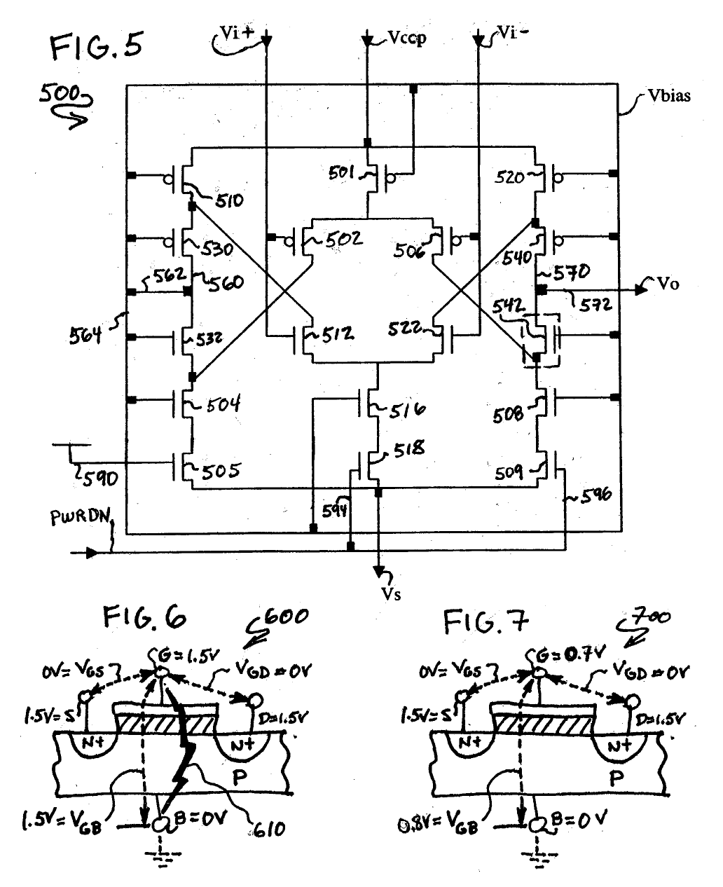

Embodiments of the present invention propose arrangements that eliminate this problem by fixing Vbias to a voltage equal to or near that of Vbias during normal circuit operation. One example arrangement is shown in FIG. 5.

More particularly, the FIG. 5 OTA circuit design is very similar to that of the FIG. 4 OTA circuit design. Included are transistors 501, 502, 504, 505, 506, 508, 509, 510, 512, 516, 518, 520, 522, 530, 532, 540, 542, as well as interconnects 560, 562, 564 (aka, Vbias), 570, 572. Such components again have the noted (and other) example circuit interconnections as shown to form two parallel complementary stages, and with Vccp representing, for example, a high voltage supply (e.g., 1.5-1.6 volts) interconnection (e.g., having a voltage level that is greater than Vmax), Vs representing, for example, a low voltage supply (e.g., ground) interconnection, Vi+ and Vi− representing ones of the reference and feedback voltages, and Vo representing an output voltage of the OTA circuit.

Again, a bias voltage formed at a node 560 (between transistors 530, 532) is fed via interconnect 562 to the distributing interconnect 564 (provided as a ring in FIG. 5), and Vbias as tapped from such interconnect is used to bias a majority of the transistors in the FIG. 4 OTA. An intermediate voltage formed at a node 570 (between transistors 540, 542) is fed via interconnect 572 as the output voltage Vo of the OTA 500.

Turning now to differences, while the FIG. 4 circuit includes three pull-down n-channel transistors (405, 418, 409) selectably controllable by PWRDN, the FIG. 5 circuit includes two, i.e, pull-down n-channel transistors 518, 509. The PWRDN signal is fed to the gates of the two pull-down transistors 518, 509 via two interconnects 594, 596, respectively. Such pull-down transistors 518, 509 control current paths of the respective FIG. 5 central and right branches, and may disable such branch circuits. In the FIG. 5 circuit, the pull-down transistors 518, 509 maintain the same functionality as the FIG. 4 pull-down transistors 418, 409.

In contrast, the FIG. 5 transistor 505 is not connected to, or controlled by, PWRDN. Instead, the transistor 505 may be hardwired on via appropriate biasing applied to the gate thereof via interconnect 590. For example, the transistor 505 may remain turned on by having its gate tied to Vcc (which is lower than Vccp). This arrangement causes the left-hand branch to maintain some voltage level of maintenance Vbias during PWRDN turn-off of the other branches. For example, a Vbias level of 0.7V may be maintained on interconnect 564 and supplied therefrom to ones of gates of the FIG. 5 transistors.

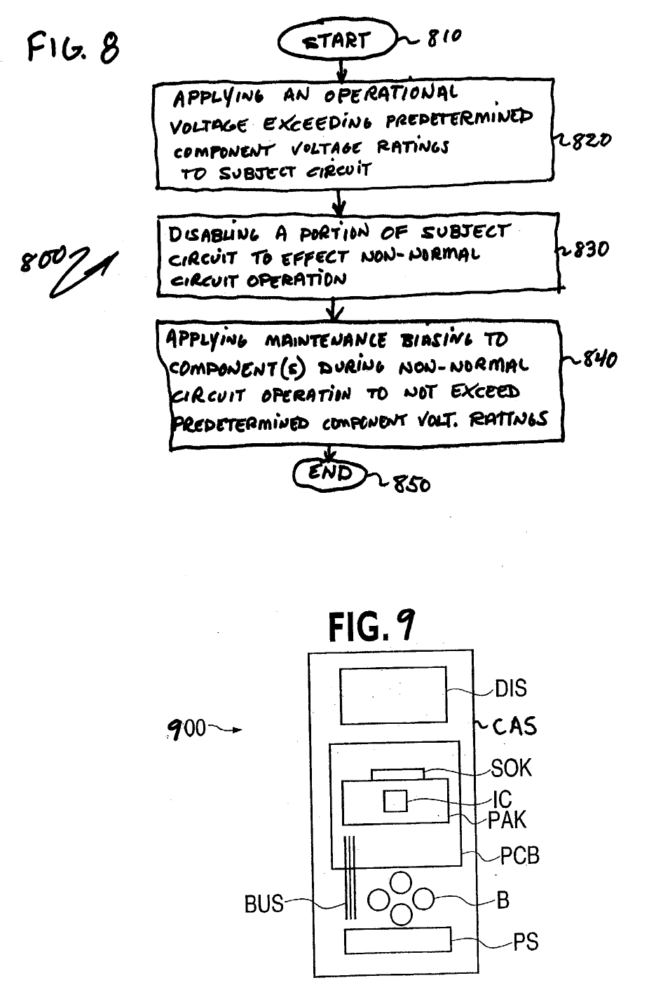

FIG. 7 is an example cross-sectional view 700 similar to that of FIG. 6, but is of an example transistor 542 from the FIG. 5 (see dash enclosed area) advantageous circuit arrangement. Again, such FIG. is useful in gaining a more thorough understanding/appreciation of the present invention. As FIG. 7 is similar to FIG. 6, redundant discussions applicable to both FIGS are omitted for the sake of brevity.

During turn-off of the two FIG. 5 pull-down transistors 518, 509 (to controllably disrupt the current paths of their respective branches), the bulk B may eventually experience a voltage of substantially 0V (B=0V), the source S and drain D may eventually experience substantially 1.5V (S=1.5V; D=1.5V), and the gate G may eventually experience substantially 0.7V (G=0.7V). That is, the gate G is biased by the maintenance Vbias level of 0.7V.

Again (similar to FIG. 6), voltage differentials across the gate-source and gate-drain pairs may be substantially 0V (Vgs=0V; Vgd=0V), and thus safely below the present example Vmax of 1.2V. More importantly, a voltage differential across the opposing gate-bulk structure may be substantially 0.8V (Vgb=0.8V). Thus, by maintaining a prescribed level of maintenance Vbias biasing during PWRDN turn-off, Vgb may thus safely be maintained below the present example Vmax of 1.2V.

That is, the FIG. 5 example circuit now eliminates unsafe voltages when the OTA provides a high voltage at its output to disable the VRM. Thus, the FIG. 5 example circuit is able to drive out a high voltage Vo when in disabled state, as well as keeping the negative input at a prescribed level during the disabled state. The above modification to the design disables the output driver transistor path enabling the high voltage, but at the same time converts the wide input range OTA to a basic OTA by disabling a portion of the circuit (e.g., one differential stage). Voltage-sensitive components within the disabled circuit portion are protected via the use of maintenance biasing from an enabled circuit portion.

FIG. 8 is an example flow 800 embodiment of the present invention. More particularly, after a start 810, an operational voltage exceeding predetermined component voltage ratings may be applied to a subject circuit (block 820). Thereafter, there may be a disabling of a portion of the subject circuit to effect a non-normal circuit operation (block 830). During non-normal circuit operation, maintenance biasing may be applied (block 840) to differing components so as to facilitate the non-normal operation (e.g., disable; power savings, etc), while at the same time maintaining protective maintenance biasing to voltage-sensitive ones of the components. With the non-limitive example shown/described with respect to FIG. 5, disabling is effectively accomplished for a portion of components by turning off an output stage, and maintenance biasing is effectively accomplished for a portion of components by keeping (hardwiring) on a non-output stage. Block 850 represents an end of the flow 800.

Although not shown in the FIG. 8 flow, circuit operation may cycle back and forth through normal and non-normal operations during operation of the circuit. That is, as one example, a circuit may enter a power savings mode a number of times over a period of time. Further, in some instances, blocks 830 and 840 may be applied upon each initialization of the subject circuit. As one example, upon power up, an IC may initialize with a self-test mode where the subject circuit if initially disabled so as to facilitate initialization testing.

The maintenance biasing technique can be applied to any OTA circuit design. For example, for the OTA shown in FIG. 3, an n-channel transistor may be added that will disable the current source connected to Vs along with an additional n-channel transistor in the Vo output branch, while leaving on the differential amplifier that is driven by the current source connected to Vc. That is, n-channel pull-down transistors may be added within dash-enclosed areas 380 and 390 (to controllably disrupt the current paths of their respective branches), and a PWRDN signal may be selectively applied thereto to disable the OTA while still maintaining high-voltage safe PWRDN biasing.

FIG. 9 illustrates example electronic system arrangements that may incorporate implementations of the present invention. More particularly, shown is an integrated circuit (IC) chip that may incorporate one or more implementations of the present invention as an IC chip system. Such IC may be part of an electronic package PAK incorporating the IC together with supportive components onto a substrate such as a printed circuit board (PCB) as a packaged system. The packaged system may be mounted, for example, via a socket SOK onto a system board (e.g., a motherboard system (MB)). The system board may be part of an overall electronic device (e.g., computer, electronic consumer device, server, communication equipment) system that may also include one or more of the following items: input (e.g., user) buttons B, an output (e.g., display DIS), a bus or bus portion BUS, a power supply arrangement PS, and a case CAS (e.g., plastic or metal chassis).

The above maintenance biasing technique can also be applied to non-OTA circuit designs. That is, while the present disclosure discloses a variation of an example OTA circuit that alleviates the high voltage degradation problem for a specific OTA design, the general maintenance biasing technique/methodology described herein may be used in the design/operation of other high voltage safe circuits.

Turning now toward closure, reference in the specification to “one embodiment”, “an embodiment”, “example embodiment”, etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment or component, it is submitted that it is within the purview of one skilled in the art to effect such feature, structure, or characteristic in connection with other ones of the embodiments and/or components. Furthermore, for ease of understanding, certain method procedures may have been delineated as separate procedures; however, these separately delineated procedures should not be construed as necessarily order dependent in their performance, i.e., some procedures may be able to be performed in an alternative ordering, simultaneously, etc.

This concludes the description of the example embodiments. Although the present invention has been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

As one example, while the FIG. 5 example embodiment achieves the 0.7V maintenance biasing by applying hardwired biasing to the gate of the transistor 505, practice of embodiments of the present invention are not limited to such static maintenance biasing. More particularly, detector arrangements may be used to real-time detect voltage differentials across voltage-sensitive structures of predetermined ones of the circuit components, and maintenance biasing applied to the components may be dynamically adjusted in real-time so as to be maintained within the predetermined voltage ratings of the components. The dynamic maintenance biasing may be advantageous over static maintenance biasing in that minimal possible biasing may be able to be maintained so as to result in power savings for the circuit.

What is claimed is:

1. A circuit with safe component biasing, the circuit comprising:
a circuit that includes at least one electronic component with a voltage-sensitive structure having a predetermined voltage rating, the circuit being powerable with an operational voltage having a higher voltage level than the predetermined voltage rating;
a disabling circuit to disable a portion of the circuit to effect a non-normal circuit operation; and,
a biasing maintainer circuit to apply maintenance biasing to at least one electronic component within the disabled portion of the circuit during the non-normal circuit operation, the maintenance biasing to maintain voltages applied across the voltage-sensitive structure of the at least one electronic component to within the predetermined voltage rating.

2. A circuit as claimed in claim 1, wherein the circuit is an operational transconductance amplifier (OTA) circuit.

3. A circuit as claimed in claim 1, wherein the circuit includes an output stage and at least one non-output stage, wherein the disabling circuit is to disable at least the output stage to effect the non-normal circuit operation, and wherein the biasing maintainer circuit is to maintain the non-output stage enabled to apply the maintenance biasing.

4. A circuit as claimed in claim 1, wherein the circuit is a semiconductor integrated circuit (IC).

5. A circuit as claimed in claim 4, wherein the non-normal circuit operation is at least one of a: disable, power-off; power-reduction; power-saving; sleep; and testing mode.

6. A circuit as claimed in claim 1, wherein the circuit is a voltage regulator (VR) circuit.

7. A circuit as claimed in claim 6, wherein the VR circuit includes an output stage and at least one non-output stage, wherein the disabling circuit is to disable at least the output stage to effect the non-normal circuit operation, and wherein the biasing maintainer circuit is to maintain the non-output stage enabled to apply the maintenance biasing.

8. A circuit as claimed in claim 6, wherein the circuit is a semiconductor integrated circuit (IC).

9. A system comprising:
at least one item selected from a list of: an electronic package, PCB, socket, bus portion, input device, output device, power supply arrangement and case; and
a circuit with safe component biasing, the circuit including:
a circuit that includes at least one electronic component with a voltage-sensitive structure having a predetermined voltage rating, the circuit being powerable with an operational voltage having a higher voltage level than the predetermined voltage rating;
a disabling circuit to disable a portion of the circuit to effect a non-normal circuit operation; and,
a biasing maintainer circuit to apply maintenance biasing to at least one electronic component within the disabled portion of the circuit during the non-normal circuit operation, the maintenance biasing to maintain voltages applied across the voltage-sensitive structure of the at least one electronic component to within the predetermined voltage rating.

10. A system as claimed in claim 9, wherein the circuit is an operational transconductance amplifier (OTA) circuit.

11. A system as claimed in claim 9, wherein the circuit includes an output stage and at least one non-output stage, wherein the disabling circuit is to disable at least the output stage to effect the non-normal circuit operation, and wherein the biasing maintainer circuit is to maintain the non-output stage enabled to apply the maintenance biasing.

12. A system as claimed in claim 9, wherein the circuit is a semiconductor integrated circuit (IC).

13. A system as claimed in claim 12, wherein the non-normal circuit operation is at least one of a: disable, power-off; power-reduction; power-saving; sleep; and testing mode.

14. A system as claimed in claim 9, wherein the circuit is a voltage regulator (VR) circuit.

15. A system as claimed in claim 14, wherein the VR circuit includes an output stage and at least one non-output stage, wherein the disabling circuit is to disable at least the output stage to effect the non-normal circuit operation, and wherein the biasing maintainer circuit is to maintain the non-output stage enabled to apply the maintenance biasing.

16. A system as claimed in claim 14, wherein the circuit is a semiconductor integrated circuit (IC).

17. A circuit with safe component biasing, the circuit comprising:
a circuit that includes at least one electronic component with a voltage-sensitive structure having a predetermined voltage rating, the circuit being powerable with an operational voltage having a higher voltage level than the predetermined voltage rating;
disabling means for disabling a portion of the circuit to effect a non-normal circuit operation; and,
biasing maintainer means for applying maintenance biasing to at least one electronic component within the disabled portion of the circuit during the non-normal circuit operation, the maintenance biasing to maintain voltages applied across the voltage-sensitive structure of the at least one electronic component to within the predetermined voltage rating.

18. A circuit as claimed in claim 17, wherein the circuit is an operational transconductance amplifier (OTA) circuit.

19. A circuit as claimed in claim 17, wherein the circuit includes an output stage and at least one non-output stage, wherein the disabling means is for disabling at least the output stage to effect the non-normal circuit operation, and wherein the biasing maintainer means is for maintaining the non-output stage enabled to apply the maintenance biasing.

20. A circuit as claimed in claim 17, wherein the circuit is a semiconductor integrated circuit (IC).

21. A circuit as claimed in claim 20, wherein the non-normal circuit operation is at least one of a: disable, power-off; power-reduction; power-saving; sleep; and testing mode.

22. A circuit as claimed in claim 17, wherein the circuit is a voltage regulator (VR) circuit.

23. A circuit as claimed in claim 22, wherein the VR circuit includes an output stage and at least one non-output stage, wherein the disabling means is for disabling at least the output stage to effect the non-normal circuit operation, and wherein the biasing maintainer means is for maintaining the non-output stage enabled to apply the maintenance biasing.

24. A circuit as claimed in claim 22, wherein the circuit is a semiconductor integrated circuit (IC).

25. A method of providing safe component biasing, comprising:
applying an operational voltage level to a circuit that includes at least one electronic component with at least one voltage-sensitive structure having a predetermined voltage rating, the operational voltage being a higher voltage level than the predetermined voltage rating;
disabling a portion of the circuit to effect a non-normal circuit operation; and,
applying maintenance biasing to at least one electronic component within the disabled portion of the circuit during the non-normal circuit operation, the maintenance biasing maintaining voltages applied across the voltage-sensitive structure of the at least one electronic component to within the predetermined voltage rating

26. A method as claimed in claim 25, wherein the circuit includes an output stage and at least one non-output stage, wherein the disabling disables at least the output stage to effect the non-normal circuit operation, and non-output stage is maintained enabled during the non-normal circuit operation for applying the maintenance biasing.

27. A method as claimed in claim 25, wherein the circuit is one of: an operational transconductance amplifier (OTA) circuit, and a voltage regulator (VR) circuit.

28. A method as claimed in claim 25, wherein the circuit is a semiconductor integrated circuit (IC).
